(19) United States
(12) Patent Application Publication
(10) Pub. No.: US 2003/0229559 A1
(43) Pub. Date: Dec. 11, 2003

(54) Asset management platform

(76) Inventors: James T. Panttaja, Healdsburg, CA (US); John Henton, Santa Rosa, CA (US); David A. Kinsfather, San Francisco, CA (US); Mahesh I. Sipahimalani, San Francisco, CA (US); Margaret L. Sorentino, Santa Rosa, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 10/412,594

(22) Filed: Apr. 8, 2003

Related U.S. Application Data
(60) Provisional application No. 60/371,544, filed on Apr. 9, 2002.
(60) Provisional application No. 60/385,008, filed on May 31, 2002.
(60) Provisional application No. 60/385,009, filed on May 31, 2002.
(60) Provisional application No. 60/385,010, filed on May 31, 2002.
(60) Provisional application No. 60/421,928, filed on Oct. 28, 2002.

(51) Int. Cl. G06F 17/60

(52) U.S. Cl. 705/36

(57) ABSTRACT

An asset management platform (AMP) processes messages from mobile assets to enable data-driven monitoring and management of the assets. The mobile assets transmit messages to the AMP specifying the assets' current locations and other information. Modules in the AMP normalize and augment the messages using state information and other data stored in a database. A router routes copies of the messages to multiple destinations, including applications and a business operations middleware (BOM) module. The BOM includes queues for holding messages of different types and subscribers for processing the messages in the queues. An event-action subscriber processes messages as specified by event-action rules. The event-action rules provide flexible and extensible asset tracking, fleet management, and notification capabilities.

### CROSS-REFERENCE TO RELATED APPLICATIONS

This application claims the benefit of U.S. Provisional Application No. 60/371,544, filed Apr. 9, 2002, U.S. Provisional Application No. 60/385,010, filed May 31, 2002, U.S. Provisional Application No. 60/385,008, filed May 31, 2002, U.S. Provisional Application No. 60/385,009, filed May 31, 2002, and U.S. Provisional Application No. 60/421,928, filed Oct. 28, 2002, all of which are hereby incorporated herein by reference.

### BACKGROUND

1. Field of the Invention

This invention pertains in general to computer-based monitoring and managing of mobile assets and in particular to a platform for providing management of a fleet of mobile assets.

2. Background Art

Many enterprises, such as business and government agencies, rely on a set of widely-distributed assets in order to conduct business. For example, a delivery service uses a fleet of trucks to make deliveries. During the day, some of the trucks are being loaded at a central depot, some trucks are at various points on their delivery routes, and other trucks have completed their routes and are heading back to the central depot. Another example is a government agency having a pool of laptop computers that are temporarily assigned to employees. At a given time, some of the laptops are at the agency's offices, other laptops are at the employees' homes, and still other laptops are “on the road” with traveling employees. A third example is a car rental agency having a fleet of cars. At a given time, some of the cars in the fleet are not rented and are stored in a parking lot or another central location. Other cars in the fleet are rented and are being driven around a city or other geographic area by the renters.

In each of these examples, the enterprise has a desire to track the movements of the mobile assets. The delivery service wants to know the locations of its trucks, the government agency wants to know the locations of its laptops, and the rental car company wants to know the locations of its cars. In addition, the enterprise may wish to track the assets' movements in a way that allows for more sophisticated analysis. For example, the delivery service may want to know if a particular truck is running late on its route or has missed a stop and the government agency may want to locate a missing laptop. Likewise, the rental car agency may want to know if the renters are violating the rental contract by traveling outside geographic limits or speeding.

Accordingly, there is a need in the art for a way to track sets of potentially-mobile assets. A solution to this need should allow flexible and extensible tracking in order to support different enterprises and asset types. Moreover, the solution should provide flexible reporting and notification tools in order to meet the goals of the enterprises.

### SUMMARY OF THE INVENTION

The above need is met by an asset management platform (AMP) having sophisticated message processing, reporting, and notification capabilities.

Each mobile asset has an asset tracking device (ATD) that allows the asset to send messages to the AMP reporting its location and other data. The AMP includes a network adapter module that interfaces with the ATDs to receive the messages. A router module routes the messages to a business operations middleware (BOM) module and/or other destinations.

The BOM module performs complex event processing and condition matching, enabling event-driven notification and multi-point routing, and providing machine-to-human, machine-to-machine, and machine-to-application communication. The BOM includes a queue router that routes the messages to zero or more processing queues. In one embodiment, the BOM includes four different processing queues to which the queue router can route messages: a message response queue; a location queue; a routing queue, and an event-action queue. Each queue is served by one or more associated subscriber modules. The subscriber modules read each message from the associated queue, perform processing of the message, and cause any output or external actions to occur in response.

The event-action queue subscriber module processes messages in the event-action queue according to event-action rules stored in a database. In one embodiment, the event-action rules include predicates and actions that realize well-defined interfaces. This decomposition allows new and custom predicates and actions to be easily added to the system. The predicates describe the possible states of the mobile asset and/or AMP, and the actions describe actions that can be performed if one or more of the predicates are satisfied. In one embodiment, the predicates are optimized to provide asset tracking and fleet management capabilities. Types of predicates include: spatial predicates, time predicates, asset input/output predicates, routing predicates, trend predicates, and movement predicates. Types of actions include: human notification actions, application notification actions, and device notification actions. The event-action queue subscriber evaluates the predicates against data in the messages and, if the predicates are satisfied, effectuates the actions.

Accordingly, a fleet manager or other end-user can establish event-action rules in the AMP to implement custom asset tracking, reporting, and notifying capabilities, as well as integration with other applications.

### BRIEF DESCRIPTION OF THE DRAWINGS

FIG. 1 is a high-level block diagram illustrating an environment including an asset management platform (AMP) according to an embodiment of the present invention;

FIG. 2 is a high-level block diagram illustrating a more detailed view of the AMP of FIG. 1 according to one embodiment and other entities that can interface with the AMP;

FIG. 3 is a high-level block diagram illustrating a more detailed view of one embodiment of the business operations middleware (BOM) module in the AMP;

FIG. 4 is a high-level block diagram illustrating one embodiment of modules in the database of the AMP; and

FIG. 5 is a flow chart illustrating steps for utilizing the AMP to perform asset tracking according to one embodiment of the present invention.

The figures depict an embodiment of the present invention for purposes of illustration only. One skilled in the art will readily recognize from the following description that alternative embodiments of the structures and methods illustrated herein may be employed without departing from the principles of the invention described herein.

### DETAILED DESCRIPTION OF THE PREFERRED EMBODIMENTS

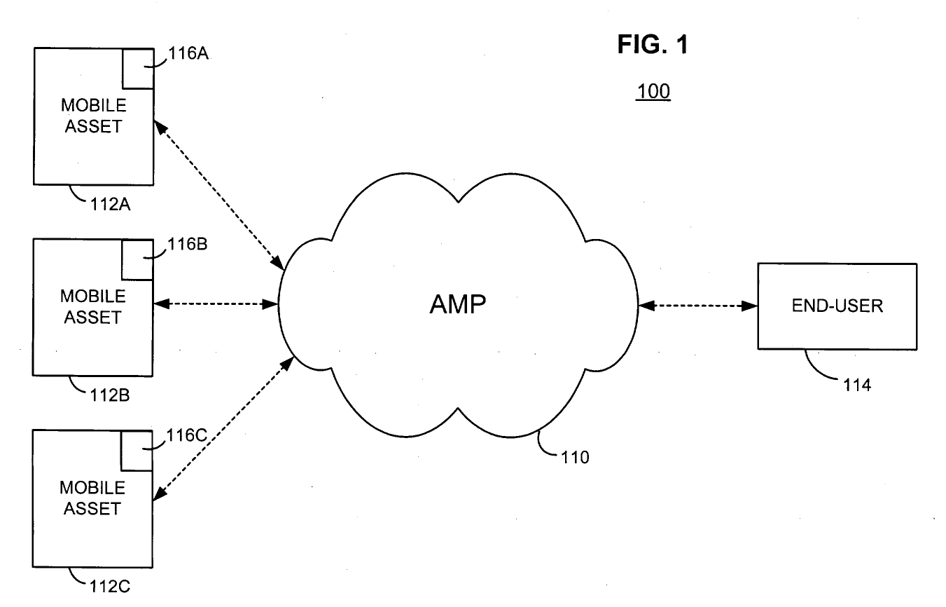

FIG. 1 is a high-level block diagram illustrating an environment 100 including an asset management platform (AMP) 110 according to an embodiment of the present invention. FIG. 1 illustrates three mobile assets 112 in communication with the AMP 110. The AMP 110, in turn, is in communication with an end-user 114. FIG. 1 and the other figures use like reference numerals to identify like elements. A letter after a reference numeral, such as “112A,” indicates that the text refers specifically to the element having that particular reference numeral. A reference numeral in the text without a following letter, such as “112,” refers to any or all of the elements in the figures bearing that reference number (e.g. “112” in the text refers to reference numerals “112A,” “112B,” “112C,” and/or “112D” in the figures).

A mobile asset 112 is a thing that can be tracked by the AMP 110. Examples of mobile assets include cars, trucks, ships, laptop and desktop computers, people, animals, packages, clothing, fine art, luggage, etc. The asset 112 need not be mobile at any given instance in time; in fact, some assets may be stationary for extended periods of time or not generally thought of as “mobile.” Accordingly, this description uses the phrase “mobile asset” to refer to both mobile and immobile assets. Only three mobile assets 112 are illustrated in FIG. 1 for purposes of clarity. However, typical environments 100 can have any number of mobile assets 112.

Each mobile asset 112 has an asset tracking device (ATD) 116. In one embodiment, the ATD 116 is a device that is physically attached to the asset 112. For example, the ATD 116 can be a device that is physically installed in a car or truck, woven into the fabric of clothing, enclosed in a suitcase, painted on the top of a truck, etc. In another embodiment, the ATD 116 is integrated into the asset itself. For example, the ATD 116 functionality can be included in a personal computer through the integration of hardware and/or software modules. The ATD 116 and the mobile asset 112 are assumed to be at the same location at any given point in time, so that the location of the ATD is a proxy for the location of the mobile asset itself. For this reason, this description sometimes treats the ATD 116 and the mobile asset 112 as the same entity.

In general, the ATD 116 supports and/or provides two functionalities: 1) position determination; and 2) position reporting. In one embodiment, the ATD 116 provides position determination by having a conventional sensor adapted to use the satellite-based Global Positioning System (GPS) to determine the ATD's 116 current longitude, latitude, altitude, heading, velocity, etc. In other embodiments, an ATD 116 uses other position determination systems, such as an inertia-based tracking system, the Galileo satellite navigation system, a cellular telephone tower or television signal triangulation system, and/or an assisted GPS system such as the wide area augmentation system (WAAS). Different ATDs 116 in the environment 100 can use different position determination systems.

In one embodiment, the ATD 116 provides position reporting by having functionality for sending electronic messages reporting the ATD's position to the AMP 110. One embodiment of the ATD 116 includes a processor and memory and is adapted to execute program code modules for generating messages. In one embodiment, the ATD 116 is configured to send messages at certain intervals, such as every 5 minutes or every day. In another embodiment, the ATD 116 is configured to send the messages upon the occurrence of one or more events, such as when the ATD's rate of acceleration exceeds a predetermined limit, when the ATD moves a certain distance, when a car door is unlocked, and/or when the ATD has moved within a certain distance of a predetermined location. The ATD 116 can also be adapted to change its position-reporting logic in response to messages received from the AMP 110 or another entity.

The messages generated by the ATD 116 preferably contain data describing aspects of its associated mobile asset 112. In one embodiment, a message contains some or all of the following data: an ATD identification (ID) specifying the ATD 116 that generated the message; a device type ID that specifies the type of ATD that generated the message; a mobile asset ID identifying the mobile asset 112 with which the ATD is associated; an enterprise ID identifying the enterprise with which the mobile asset/ATD is associated; a message type field specifying the event that caused the message to be generated; a status message field identifying the status of one or more sensors of the mobile asset; location information describing the current location of the mobile asset; and time information specifying the date/time when the message was generated. Messages can include other data in addition to, or instead of, the data described herein.

In one embodiment, the ATD 116 uses conventional cellular wireless communication technologies to exchange messages with the AMP 110, including cellular telephone technologies using the cell control channel, cellular digital packet data (CDPD), general packet radio service (GPRS), etc. The ATD 116 can also use conventional wireless computer networking technologies, such as 802.11, to communicate with the AMP 110. In other embodiments, the ATD 116 utilizes satellite-based communication technologies, non-cellular based radio communication technologies, and/or other technologies. Communication between the ATD 116 and the AMP 110 is preferably bi-directional and the ATD and AMP can utilize different technologies for different directions of communication.

In one embodiment, at least some of the functionality of the ATD 116 is performed in combination with another entity. For example, the ATD 116 include a radio frequency (RF) identification (RFID) tag or bar code that is read when it comes within range of a scanner. The scanner, in turn, generates the message and transmits it to the AMP 110.

The AMP 110 exchanges messages with the ATDs 116 and provides sophisticated data-driven message processing capabilities. The processing capabilities are utilized to provide monitoring, managing, reporting, and notifying functionality to the end-users 114. For example, in one embodiment the AMP 110 provides functionality for monitoring and managing a fleet of trucks on delivery routes. AMP 110 processes messages from the trucks to perform functions such as determining whether trucks are on schedule, whether trucks have deviated from assigned routes, whether the trucks are speeding, etc.

The end-user 114 illustrated in FIG. 1 is representative of a person, computer system, application, or other entity that communicates with the AMP 110 to access the monitoring, managing, reporting, and/or notifying functionalities. The AMP 110 and end-user 114 can communicate via a variety of technologies and interfaces. For example, the end-user can communicate with the AMP 110 using a telephone-based interactive voice response (IVR) interface, a web page-based interface, an email interface, data exchanged via a network connection utilizing the transmission control protocol/Internet Protocol (TCP/IP), and/or a dedicated application interface. The end-user 114 can utilize a variety of devices to access these interfaces, including a telephone, computer system, pager, etc. These communications can utilize conventional wired and/or wireless data and/or voice communications links. Although only one end-user 114 is shown in FIG. 1, embodiments of the environment 100 have many end-users.

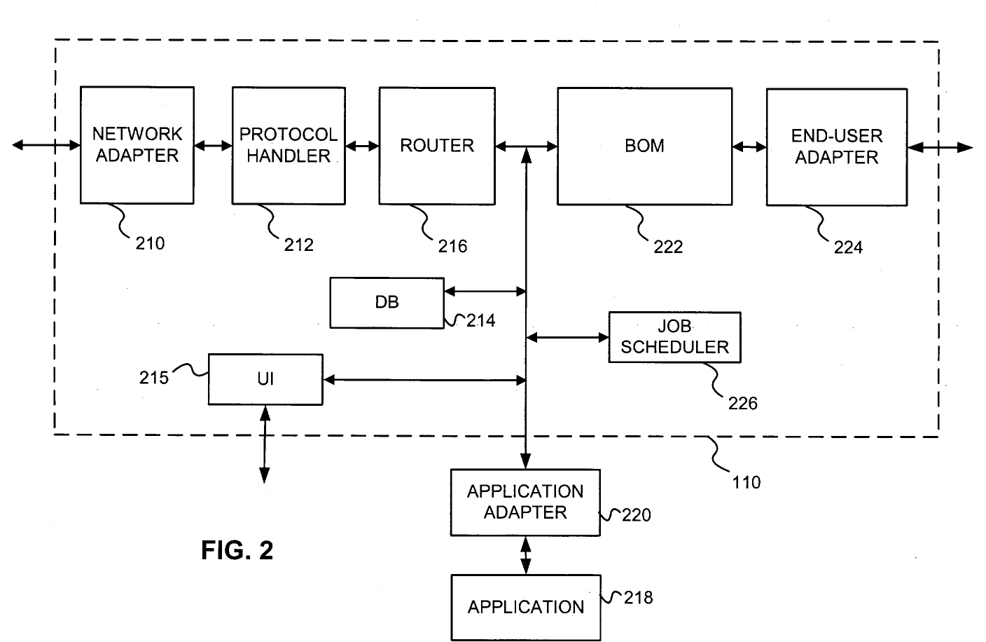

FIG. 2 is a high-level block diagram illustrating a more detailed view of one embodiment of the AMP 110 and other entities interfacing with the AMP. In one embodiment, the AMP 110 comprises one or more modules executing on a conventional computer system. As used herein, the term “module” refers to computer program logic and/or any hardware or circuitry utilized to provide the functionality attributed to the module. Thus, a module can be implemented in hardware, firmware, and/or software. Embodiments of the AMP 110 can have different and/or additional modules than the ones described herein. Moreover, in different embodiments the functionality of the AMP 110 is distributed throughout the modules in a manner different than described herein.

The AMP 110 includes a network adapter module 210 (referred to herein as the “network adapter”) for interfacing with the mobile assets 112. The network adapter 210 includes functionality for receiving messages from the mobile assets 112 and for sending messages to the mobile assets. In one embodiment, the network adapter 210 is comprised of multiple sub-adapters, with each sub-adapter configured to interface with a particular communication medium utilized by the mobile assets 112. For example, in one embodiment a sub-adapter is configured to interface with the mobile assets 112 via cellular telephone network technologies such as CDPD and/or GSM, a second sub-adapter is configured to interface with the mobile assets via networking links to the Internet, and a third sub-adapter is configured to interface via a satellite-based communications medium.

The formats of the messages exchanged between the network adapter 210 and the mobile assets 112 vary depending upon the communication technology and media utilized to transport the messages. For example, the messages can be formatted to provide data in fixed-width fields, to provide data as name=value statements, and/or to provide data as name/length/value statements. In one embodiment the messages are transported over a packet-switched network and, therefore, are encapsulated in a packet-based representation. Other embodiments utilize other data representations for the messages.

The network adapter 210 converts messages received from mobile assets 112 from the representation utilized by the mobile assets into a standardized representation utilized by the AMP 110 (and vice versa). In one embodiment, the standardized representation is an extensible markup language (XML)-based well-formed data structure having fields and corresponding data that can be read by the other modules in the AMP 110. In one embodiment, the characteristics of the data structure are determined by the type of ATD 116, communication media, and/or sub-adapter involved in the message exchange.

A protocol handler 212 is adapted to receive the messages (i.e., the data structures corresponding to the messages) from the network adapter 210. For each message, the protocol handler 212 preferably discerns how to read the data structure. In one embodiment, the protocol handler 212 reads the device type ID and a network adapter ID (added by the network adapter 210) from the message. These two IDs allow the protocol handler 212 to identify the type of ATD 116 and communication medium. The protocol handler utilizes this information to parse the data structure of the message and access the data contained therein.

The protocol handler 212 also preferably augments the message by adding any missing information that can be derived from the data in the message. For example, in one embodiment the message from the mobile asset 112 includes a device ID but not an enterprise ID. The protocol handler 212 accesses a database 214 correlating device IDs with enterprise IDs and obtains the enterprise ID associated with the message. The protocol handler 212 inserts the enterprise ID into the message.

A database module 214 (referred to herein as the “database”) holds data utilized by the other modules in the AMP 110 to process the messages. The database 214 is described in more detail below.

A user interface (UI) module 215 provides an interface through which an end-user 114 can access the functionality of the AMP 110. In one embodiment, the UI module 215 provides a graphical user interface (GUI) that an end-user can access via the Internet, another computer network, and/or a direct connection in order to monitor and configure the AMP 110. The GUI includes a series of web pages with which the end-user 114 interacts.

A router module 216 (referred to herein as the “router”) is adapted to receive augmented messages from the protocol handler 212 and route the messages to one or more destinations. Routing tables 412, stored in the database 214 and/or another location, specify where to route the messages. The router 216 analyzes the data in the message, applies the routing tables 412 to the data, and routes the data accordingly. In one embodiment, the routing tables 412 specify that the router 216 route a copy of every message to a business operations middleware (BOM) module 222 (referred to herein as the “BOM”) in the AMP 110.

The routing tables 412 can also specify that the router 216 route copies of messages to the protocol handler 212 and/or to application modules 218 (referred to herein as “applications”). The applications 218 can be internal or external to the AMP 110. The router 216 thus provides a way for non-AMP-based applications 218 to tap into the stream of messages to/from the mobile assets 112 and BOM 222. For example, an enterprise using the AMP 110 to track a fleet of mobile assets 112 can execute an application 218 that processes messages from assets in the fleet. In order to display a map with real time locations of assets, allow dynamic routing of assets, etc. In one embodiment, the applications 218 utilize application adapters 220 to convert messages received from the router 216 into formats suitable for the applications (and vice-versa).

The BOM 222 performs complex event processing and condition matching, enabling event-driven notification and multi-point routing, and providing machine-to-human and machine-to-machine communication. The BOM 222 also provides uninterrupted operation when message processing logic is altered and/or new mobile assets 112 are introduced to the environment 100.

An end-user adapter module 224 (referred to herein as the “end-user adapter”) interfaces with end-users 114. The end-user adapter 224 converts messages to the end-users 114 from the format utilized by the BOM 222 and/or other modules in the AMP 110 into the proper format for communicating the message. For example, the end-user adapter 224 can convert an output message into a voice message, an email, an update on a web page, etc.

A job scheduler module 226 (referred to herein as the “job scheduler”) supports functionality in the AMP 110 utilizing timing and/or scheduling. The job scheduler 226 is called by other modules in the AMP 110 to establish timers. The job scheduler 226 maintains state information about the timers and generates timer messages when a timer expires. The timer messages include meta-information describing the reason for the timer and the mobile asset 112, enterprise, or other entity with which it is associated. The timer messages are provided to the router 216 for processing in the same manner as other messages.

As described above, the operation of the AMP 110 is preferably bi-directional. Thus, application modules 218 and/or BOM 222 can generate, process, and send messages to the mobile assets 112. Those of skill in the art will recognize that the operation of the various modules may vary depending upon whether a module is receiving a message from the mobile assets 112 or sending a message to a mobile asset.

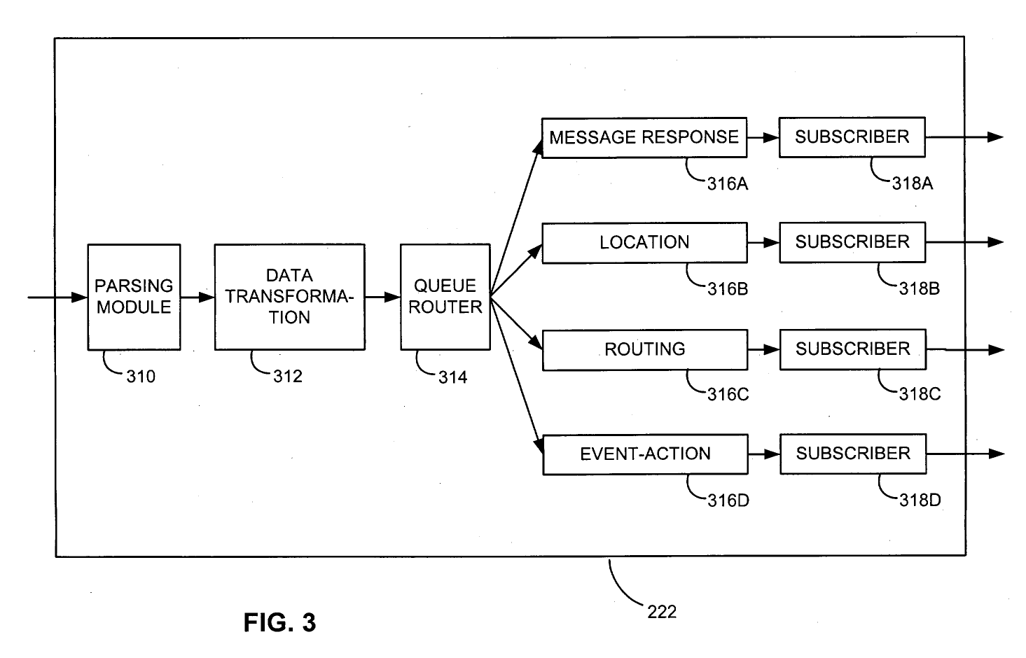

FIG. 3 is a high-level block diagram illustrating a more detailed view of the BOM 222 of FIG. 2. Messages sent by the router 216 to the BOM 222 are received by a parsing module 310 (referred to herein as the “parser”). The parser 310 parses each well-formed data structure of a message into an internal representation of the message utilized by the BOM 222. In one embodiment, the internal representation is an XML-based data structure.

The parser 310 passes the message (i.e., the internal representation of the message) to a data transformation module 312 (referred to herein as the “data transformer”). The data transformer 312 augments the message by adding state information and other data stored in the database 224 to produce a fully-formed, normalized message. In one embodiment, the data transformer 312 normalizes the message received from the mobile asset 112 into a specific category of message utilized by the BOM 222. For example, the data transformer 312 can normalize an “ignition off” message received from a mobile asset 112 into an “asset stopped” message and normalize an “airbag deployed” message from a mobile asset into an “asset crashed” message.

The data transformer 312 passes the normalized messages to a queue routing module 314 (referred to herein as the “queue router”). The queue router 314 uses routing tables to route the messages to zero or more processing queues based on the message types and/or other information in the message. In one embodiment, the BOM 222 includes four different processing queues 316 to which the queue router 314 can route messages: a message response queue 316A; a location queue 316B; a routing queue 316C; and an event-action queue 316D.

The message response queue 316A stores messages received from mobile assets 112 in response to queries sent to the assets. For example, the AMP 110 can send a message to a mobile asset 112 requesting that the asset report its position and/or the status of a sensor. When the mobile asset 112 generates a response message, the queue router 314 routes a copy of the message to the message response queue 316A.

The location queue 316B stores messages describing the current locations of mobile assets 112. In one embodiment, most messages from mobile assets 112 include location information and, therefore, the queue router 314 routes copies of most messages into the location queue 316B.

The routing queue 316C stores messages that come from mobile assets 112 that are operating geographic routes (e.g., delivery routes). If the queue router 314 determines that the message is from a mobile asset 112 on a geographic route, the queue router routes a copy of the message to the routing queue 316C.

The event-action queue 316D stores messages having associated event-actions stored in the database 214. In general, the event-actions are processing rules that act on messages. It will be understood that not every event has an associated action. Indeed, the event-action rules provide flexibility in responding to messages from mobile assets and allow the behavior of the AMP 110 to be data-driven and context-sensitive. If the queue router 314 determines that the message and/or mobile asset 112 has associated event-actions, the queue router routes a copy of the message to the event-action queue 316D. In one embodiment, the queue router 314 identifies applicable event-action rules by querying the database 214 for rules associated with the message, the ID of the mobile asset 112, the ID of the ATD 116, the ID of an enterprise with which the mobile asset is associated, etc.

Each queue 316 is served by one or more associated subscriber modules 318 (referred to herein as “subscribers”). The subscribers 318 read each message from the associated queue, perform processing of the message, and cause any output or external actions to occur in response. In one embodiment, each queue 316 has a dedicated subscriber 318 that contains functionality for dealing with the type of messages in the queue. There can be multiple instances of a subscriber 318 and, in one embodiment, each message in a queue 316 is handled by a separate instance of the appropriate subscriber.

Turning now to the specific subscribers 318, the message response subscriber 318A processes the responses from the mobile assets 112 and updates the database 214 if necessary. For example, if a response includes a value of a sensor at the mobile asset 112, the subscriber 318A updates an appropriate field in the database 214 with the value of the sensor. The message response subscriber 318A also communicates the content in the responses to the application 218 and/or end-user 114 that initially requested the response. In one embodiment, the message response subscriber 318A also acts as an exception handler. If a response from a mobile asset 112 contains an abnormal or unexpected value and/or other data indicative of a problem with the mobile asset, the message response subscriber 318A flags the exception and initiates an exception handling routine. This routine can, for example, update a value in the database 214, send an alert notification to an end-user 114, insert a message in another queue, and/or perform other actions.

In one embodiment, the message response subscriber 318A maintains state information in the database 214 allowing it to associate responses in the message response queue 316 with messages sent to the mobile assets 112. For example, the message response subscriber 318A can use the device ID associated with the mobile asset's ATD 116 to pair messages sent to and received from the mobile asset.

The location queue subscriber 318B manages an asset location information module 414 in the database 214. The location queue subscriber 318B reads current locations from the messages in the location queue 316B and updates the module 414 in the database 214 to reflect the assets reported locations.

The routing queue subscriber 318C updates mobile asset geographic route information in the database 214 in response to the data in the messages in the routing queue 316C. For example, the subscriber 324 can update the database 214 to indicate that a mobile asset 112 has made a stop on a route, is running late, has finished the route, etc.

The event-action queue subscriber 318D processes messages according to event-action rules stored in the database 214. In general, the event-action queue subscriber 318D receives a message from the queue, queries the database 214 to identify the event-action rules that apply to the message, evaluates the events, and performs any specified actions.

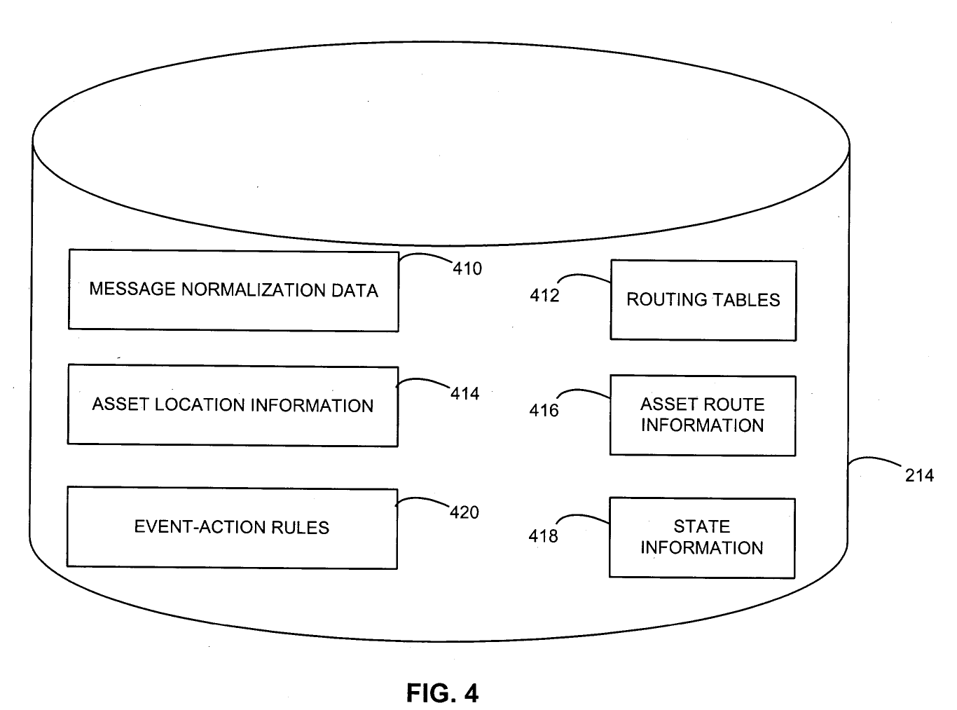

FIG. 4 is a high-level block diagram illustrating modules in the database 214 according to one embodiment of the AMP 110. In different embodiments of the AMP 110, the database 214 holds different and/or additional modules than those described herein. Although FIGS. 2 and 4 illustrate a centralized database 214, embodiments of the AMP 100 have distributed databases.

The database 214 includes a message normalization data module 410. This module 410 holds data utilized by the network adapter 210, protocol handler 212, parser 310, data transformer 312 and/or other modules in the AMP 110 to normalize and augment messages received from the mobile assets 112. For example, in one embodiment the message normalization data module 410 holds data correlating device IDs and enterprise IDs.

A routing tables module 412 holds routing tables for use by the router 216, queue router 314, and/or other modules in the AMP 110. An asset location information module 414 describes the locations of the mobile assets 112, including the current locations and travel histories. An asset route information module 416 describes geographic routes associated with the mobile assets 112 and related information, such as whether a mobile asset has completed stops on the route. A state information module 418 holds data describing the state of the AMP 110, such as information utilized by the message response queue subscriber 318A to pair messages and responses.

An event-action rules module 420 stores event-action rules utilized by the event-action queue subscriber 318D to process messages in the event-action queue 316D. In one embodiment, the event-action rules module 420 stores predicates and actions representing potential event-action rules. The predicates describe the possible states of the mobile asset 112 and/or AMP 110, and the actions describe actions that can be performed if one or more of the predicates are satisfied. The event-action rules module 420 also stores data describing predicates and actions that have been combined to form instances of event-action rules applicable to specific mobile assets, enterprises, etc. In one embodiment, event-action rules are represented as a set of IF {PREDICATE} THEN {ACTION} statements.

In one embodiment, the predicates are optimized to provide asset tracking and fleet management capabilities. To this end, there are several classes of predicates: spatial predicates, time predicates, asset input/output (I/O) predicates (also referred to as “sensor control predicates”), routing predicates, trend predicates, and movement predicates. Multiple predicates can be combined using conditional logic to form complex predicates. In addition, additional predicates can be made available to the platform 110 by loading new predicates into the event-action rules module 420. Other embodiments have other classes of predicates instead of, or in addition to, the ones described herein.

Spatial predicates evaluate the location of a mobile asset 112. For example, a spatial predicate can determine if a mobile asset 112 is within a certain distance of a location, if the asset has violated specified geographic borders (e.g., borders established by a geofence), etc.

Time predicates evaluate the behavior of the mobile asset 112 with respect to a time limit or time period. For example, a time predicate can determine whether a mobile asset 112 has moved within the last X minutes, whether the asset has reported its position within a specified time interval, whether the asset has remained near a geographic location for longer than a specified interval, etc.

Sensor control predicates evaluate the condition of a sensor at the mobile asset 112. For example, a sensor control predicate can determine whether an ignition is on or off, whether a door is open or closed, whether an air bag has deployed, the amount of gas in a gas tank, etc.

Routing predicates evaluate the condition of a mobile asset 112 with respect to a geographic route. For example, a routing predicate can determine whether an asset has made a stop on the route, whether the asset is behind or ahead of schedule, whether the asset is within X minutes of making a delivery, etc.

Trend predicates evaluate the current message in the context of historical messages received from a mobile asset 112. For example, a trend predicate can assess whether an asset has failed to maintain its delivery schedule for the second time in a week, whether an asset 112 has exceeded a speed limit for the third time in a 24 hour period, etc.

Movement predicates evaluate the current rate of travel reported by the mobile asset 112. For example, a movement predicate can determine whether a current rate of travel exceeds or falls below a set limit (e.g., whether the mobile asset is speeding), whether an average rate of travel exceeds or falls below a set limit, etc.

The actions in the event-action rules module 420 describe output and control functions that the AMP 110 can perform if one or more predicates is satisfied. As with predicates, additional actions can be added to the platform 110 by loading the actions into the event-action rules module 420. Other embodiments have other types of actions instead of, or in addition to, the ones described herein.

The output functions generally provide notifications to humans, applications, and/or ATDs 116. The human notifications include making a telephone call, sending an electronic page, updating a web page or an IVR system, etc. Application notifications include calling a function in an application program interface (API), sending a message to an application via the Internet or another network, updating a module in the database 214, etc. Device notifications include sending a message to an ATD 116 at one or more mobile assets 112 in order to update data stored at the ATD, reconfigure the ATD, and/or change the ATD's behavior. The control functions generally establish or alter control logic in the AMP 110. For example, a control function can update a module in the database 214, insert a message into one or more of the queues 316, and/or interface with the job scheduler 226 to start or stop a timer.

In one embodiment, the event-action rules are established by an end-user 114 who utilizes the GUI provided by the UI module 215 to select and associate predicates and actions. In another embodiment, the end-user 114 selects and activates pre-established event-action rules.

The event-action rules allow the AMP 110 to perform many asset tracking and fleet management functions. For example, the event-action rules can be configured to automatically place a telephone call to a person when a taxi is nearing a pickup location. Likewise, the event-action rules can be configured to send a page to a fleet manager when a sensor at a mobile asset 112 indicates than an airbag has deployed. In another example, the event-action rules can tell a billing application to bill a customer once a truck has made a delivery at the customer's location.

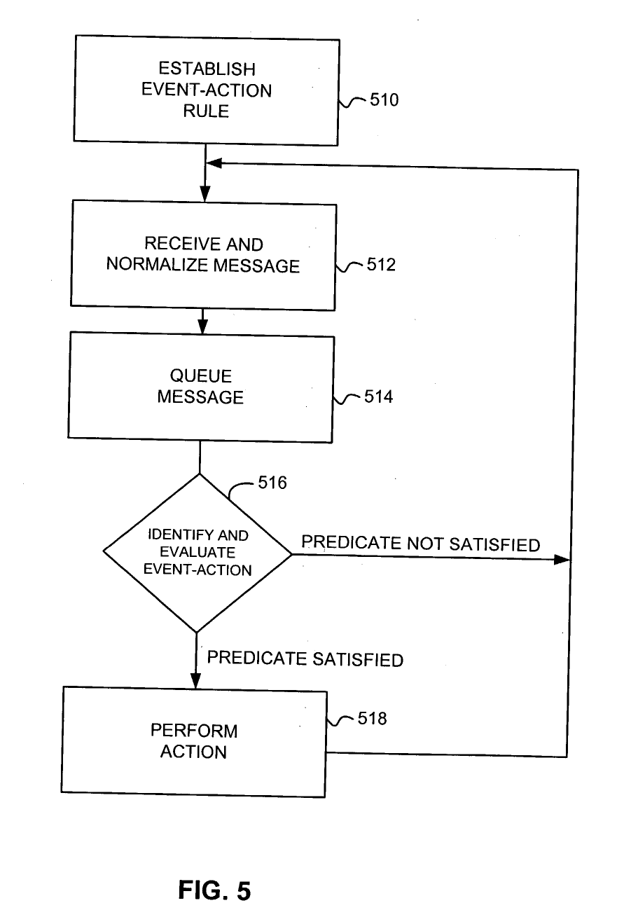

FIG. 5 is a flow chart illustrating steps for utilizing the AMP 110 to perform asset tracking according to one embodiment of the present invention. It should be understood that other embodiments of the present invention may perform different and/or additional steps than those described herein in order to perform different and/or additional tasks. Furthermore, the steps can be performed in different orders and/or performed by different entities than described herein. In one embodiment, the AMP 110 performs multiple instances of the steps concurrently as messages are received from, and sent to, the mobile assets 112.

Initially, an end-user 114 establishes 510 an event-action rule. This step can be performed by a person using a web browser to access web pages provided by the UI module 215, by an application 218 executing autonomously, or by another entity in communication with the AMP 110. In one embodiment, the event-action rule is established by identifying a pre-existing rule, marking it as active, and supplying any parameters utilized by the rule's predicates and/or actions. The AMP 110 stores the event-action rule in the database 214.

At some point after the event-action rule is established 510, the AMP 110 receives 512 a message from a mobile asset 112. For example, the message can be a periodic location update. The modules in the AMP 110 normalize and augment the received message (if necessary), to create a fully-formed message.

The queue router 314 analyzes the message and places 514 it in the one or more queues 316 in the BOM 222 appropriate for the message. The message typically includes the location of the mobile asset 112 and, therefore, the queue router 314 places a copy of the message in the location queue 316B. If the queue router 314 determines that the message has associated event-action rules in the database 214, the queue router places a copy of the message in the event-action queue 316D. The queue router 314 can also place the message in one or more of the other queues 316 depending upon the characteristics of the message.

Each subscriber 318 associated with a queue that received a copy of the message reads the message from the queue 316 and processes the message. In particular, the subscriber 318D for the event-action queue 316D reads the message from the queue and queries the database 214 to identify 516 the associated event-action rules. The subscriber 318D evaluates 516 the event-action rule. If the predicate(s) for the event-action rule is satisfied, the subscriber 316D performs 518 the specified action(s) (or calls other modules that perform the action). If the predicate(s) is not satisfied, the subscriber 318D does not perform the action. Once the action is performed, or if no actions are performed, the process returns to step 512 where it waits for another message from a mobile asset 112 or other source.

The following “long stop” example illustrates how the AMP 110 can be used to perform asset tracking in the real world. A “long stop” occurs when a mobile asset 112 does not move for a predetermined time period. Assume a fleet manager wants to be notified when a truck on a route remains immobile for longer than 30 minutes. Thus, the fleet manager establishes 510 an event-action rule for detecting a long stop. The fleet manager uses the GUI provided by the UI module 215 to define and activate a rule stating:

IF

MOBILE ASSET is immobile for TIME PERIOD

THEN

NOTIFY END-USER.

In this rule, “MOBILE ASSET” is a parameter that indicates the asset or assets for which the rule is applicable, “TIME PERIOD” is a parameter that indicates the length of time that MOBILE ASSET must be immobile in order to satisfy the predicate, “NOTIFY” is a parameter that indicates the type of action to perform if the predicate is satisfied, and “END-USER” is a parameter indicating the person or other entity to whom the action is directed. The fleet manager uses the GUI to specify that “MOBILE ASSET” is the trucks in the fleet, “TIME PERIOD” is 30 minutes, “NOTIFY” is a telephone call, and “END-USER” is the fleet manager. The AMP 110 stores the event-action rule in the database 214.

The AMP 110 receives and normalizes messages from the trucks in the fleet. Certain messages from the trucks are normalized into “asset stopped” messages that indicate that the trucks have stopped moving. These messages are processed by the BOM 222, where the subscriber 318D for the event-action queue 316D correlates the message with the long stop rule from the database 214.

To effectuate the long stop event-action rule, the event-action queue subscriber 318D calls the job scheduler 226 and activates a 30 minute timer associated with the stopped truck. After 30 minutes, the job scheduler 226 generates a message indicating that the timer expired and including metadata allowing the subscriber 318D to associate the timer message with the stopped truck. The timer message is placed in the event-action queue 316D. Upon receipt of the timer message from the queue 316D, the subscriber 318D examines the asset location information 414 in the database 214 to determine whether the truck has moved since the timer was set. If the truck has not moved, the “long stop” predicate is satisfied. Therefore, the subscriber 318D carries out the action by having the end-user adapter 224 place a telephone call to the fleet manager.

In sum, the AMP 110 according to the present invention provides an intelligent, articulated, and configurable platform for performing fleet management and other asset tracking functions. The platform provides customizable real-time event-actions and intelligent data routing and integration. Moreover, the platform is highly-scalable and supports multiple types of ATDs 116 and communication media.

The above description is included to illustrate the operation of the preferred embodiments and is not meant to limit the scope of the invention. The scope of the invention is to be limited only by the following claims. From the above discussion, many variations will be apparent to one skilled in the relevant art that would yet be encompassed by the spirit and scope of the invention.

1. An asset management platform, comprising:
a database module for holding data for managing mobile assets, the data including event-action rules specifying processing for messages received from the mobile assets;
a network adapter module for receiving a message from a mobile asset, the message including data describing aspects of the mobile asset;
a business operations middleware (BOM) module for processing the received message responsive to the data describing aspects of the mobile asset and the event-action rules in the database module.

2. The asset management platform of claim 1, wherein the network adapter module is adapted to receive messages from mobile assets via a plurality of transmission media.

3. The asset management platform of claim 1, wherein the network adapter module is adapted to receive messages from mobile assets via cellular communication technologies.

4. The asset management platform of claim 1, wherein the network adapter is adapted to engage in bi-directional communication with the mobile asset.

5. The asset management platform of claim 1, further comprising a protocol handler module for parsing the data describing aspects of the mobile asset and augmenting the message responsive to the parsed data and the data for managing mobile assets in the database to produce an augmented message.

6. The asset management platform of claim 5, further comprising:
a router module for routing the message from the mobile asset to selected ones of a plurality of destinations responsive to data in the augmented message.

7. The asset management platform of claim 1, wherein the database further holds state information for the asset management platform and wherein the BOM module comprises:
a data transformation module for augmenting the data describing aspects of the mobile asset with the state information in the database and generating a normalized message storing the augmented data in a standardized representation.

8. The asset management platform of claim 7, wherein the standardized representation utilizes an extensible markup language.

9. The asset management platform of claim 1, wherein the BOM module comprises:
a plurality of message queue modules, each message queue module adapted to hold a particular type of message generated by the mobile assets; and
a queue router module adapted to route the message to one or more of the plurality of message queue modules responsive to the data describing aspects of the mobile asset.

10. The asset management platform of claim 9, wherein the plurality of message queue modules comprise two or more of:
a message response queue module for holding messages generated by mobile assets in response to messages from the asset management platform;
a location queue module for holding messages from mobile assets in which the data describing aspects of the mobile asset include a location of the mobile asset;
a routing queue module for holding messages from mobile assets having associated geographic routes; and
an event-action queue for holding messages from mobile assets having associated event-action rules in the database.

11. The asset management platform of claim 9, further comprising:
message queue subscriber modules associated with each of the message queue modules, a message queue subscriber module adapted to read the message from its associated message queue module and process the message responsive to the data describing aspects of the mobile asset in the message and the particular type of message of which the associated message queue is adapted to hold.

12. The asset management platform of claim 11, wherein the message queue subscriber modules comprise:
a location queue subscriber module adapted to determine a location of the mobile asset responsive to the data describing aspects of the mobile asset in the message and update asset location information in the database responsive thereto.

13. The asset management platform of claim 11, wherein the message queue subscriber modules comprise:
a routing queue subscriber module adapted to update geographic route information in the database responsive to the data describing aspects of the mobile asset in the message.

14. The asset management platform of claim 11, wherein the message queue subscriber modules comprise:
an event-action queue subscribe module adapted to process the message responsive to the event-action rules in the database.

15. The asset management platform of claim 1, further comprising:
an end-user adapter module for providing output messages to end-users responsive to the processing of the messages specified by the event-action rules.

16. The asset management platform of claim 1, further comprising:
a job scheduler module for generating timing messages responsive to the processing of the messages specified by the event-action rules.

17. An asset management platform comprising:
an event-action rules module for storing event action rules for use in processing messages received from mobile assets, the event-action rules comprising:
a set of predicates describing possible states of the mobile assets and/or the asset management platform; and
a set of actions to perform responsive to satisfaction of one or more of the set of predicates; and
a processing module for receiving messages from mobile assets, identifying event-action rules in the event-action rules module applicable to the messages, and applying the event-action rules to the messages.

18. The asset management platform of claim 17, wherein the predicates are optimized to provide asset tracking and fleet management capabilities.

19. The asset management platform of claim 17, wherein the set of predicates comprise one or more of the following:
spatial predicates for evaluating locations of the mobile assets;
time predicates for evaluating possible states of the mobile assets and/or the asset management platform with respect to time periods;
sensor control predicates for evaluating possible states of sensors at the mobile assets;
trend predicates for evaluating possible states of the mobile assets in view of historical states of the mobile assets;
routing predicates for evaluating possible states of the mobile assets and/or the asset management platform with respect to geographic routes associated with one or more of the mobile assets; and
movement predicates for evaluation current rates of travel of the mobile assets.

20. The asset management platform of claim 17, wherein the actions comprise one or more of the following:
human notification actions for providing a notification to a human end-user of the asset management platform;
application notification actions for providing a notification to a program module via an application program interface; and
device notification actions for providing a message to a mobile asset.

21. The asset management platform of claim 17, wherein the actions comprise:
control actions for establishing and/or altering control logic in the asset management platform.

22. A method of managing a mobile asset, comprising:
establishing an event-action rule for the mobile asset, the event-action rule including a predicate describing an aspect of the mobile asset and an action to be performed responsive to satisfaction of the predicate;
receiving a message from the mobile asset, the message including data describing aspects of the mobile asset;
evaluating the predicate of the event-action rule with the data describing aspects of the mobile asset in the message; and
performing the action of the event-action rule responsive to satisfaction of the predicate.

23. The method of claim 22, further comprising:
normalizing the message into a category selected from a plurality of message categories responsive to the data describing aspects of the mobile asset.

24. The message of claim 22, further comprising:
deriving additional data associated with the mobile asset responsive to the data describing aspects of the mobile asset; and
augmenting the message from the mobile asset with the additional data.
